(19) United States
(12) Patent Application Publication
(10) Pub. No.: US 2024/0403920 A1
(43) Pub. Date: Dec. 5, 2024

(54) BUNDLED ADVERTISING SERVICE PROVIDING SYSTEM, METHOD FOR PROVIDING BUNDLED ADVERTISING SERVICE, AND NON-TRANSITORY RECORDING MEDIUM STORING COMPUTER-READABLE PROGRAM

(71) Applicant: KONICA MINOLTA, INC., Tokyo (JP)

(72) Inventor: Yasushi TSUE, Tokyo (JP)

(73) Assignee: KONICA MINOLTA, INC., Tokyo (JP)

(21) Appl. No.: 18/660,480

(22) Filed: May 10, 2024

(30) Foreign Application Priority Data
May 29, 2023 (JP) 2023-088090

(51) Int. Cl. G06Q 30/0251

(52) U.S. Cl. CPC G06Q 30/0269

(57) ABSTRACT

A bundled advertising service providing system enables an advertiser to place an advertisement for an appropriate target customer and reduces time and effort required for bundling an advertising leaflet. The bundled advertising service providing system includes a platform providing apparatus, the platform providing apparatus includes a hardware processor, the hardware processor selects, as an advertising leaflet to be bundled, an advertising leaflet with a high reward set for attribute information of a customer targeted by an advertiser that requests to bundle the advertising leaflet in the package, based on the attribute information of the customer to whom the package is to be sent, and the hardware processor outputs, to a printing apparatus, an instruction to print document data of the selected advertising leaflet.

### CROSS-REFERENCE TO RELATED APPLICATION

The entire disclosure of Japanese patent Application No. 2023-088090, filed on May 29, 2023, is incorporated herein by reference in its entirety.

### BACKGROUND OF THE INVENTION

### 1. Technical Field

The present invention relates to a bundled advertising service providing system, a method for providing a bundled advertising service, and a non-transitory recording medium storing a computer-readable program.

### 2. Description of Related Art

Conventionally, as an advertisement method for a product, a service, or the like, a method has been mainly used in which mass advertising media guided to an unspecified large number of people, such as television, radio, a newspaper, a leaflet, and a magazine, are used to introduce consumers' needs to the product, the service, or the like. However, with such mass advertising media, it has become difficult to expect a high advertising effect that meets consumers' needs which have increased in recent years. Therefore, personalized advertisements that emphasize the needs of individual customers are attracting attention.

A personalized advertisement targets and advertises customers who have higher needs for merchandise of a company. As the personalized advertisement, a bundled advertising service or the like is known. The bundled advertising service is a service for receiving an advertising fee from an advertiser by bundling, in a package to be sent to a regular home-delivery member of the company, a leaflet of another company (advertiser).

An electronic commerce (EC) business operator having a periodic home-delivery member has a customer segment specialized for a certain segment. Therefore, in many cases, a leaflet of a product having a high affinity for a product handled by the EC business operator highly appeals to customers of the EC business operator.

For example, a customer of an EC business operator that performs regular home delivery of food ingredient kits has the following example characteristics.
Working mothers and dual-income couples who have no children (DINKS) in their 30s to 40s are the majority.
The proportion of households with high disposable income is high.
In a case where a product or a service is of high quality, there is a tendency for consumers to have a high desire to consume it, even if it is a high-priced product or service.
The rate of repeated purchase of cosmetics is very high.

Therefore, the advertiser has the EC business operator having the same customer segment as the customer segment targeted by the advertiser bundle an advertising leaflet of an advertiser's product together with a product, a catalog, or the like to be delivered to a periodic home-delivery member, and thus can expect that the periodic home-delivery member purchases the advertiser's product.

For example, Japanese Unexamined Patent Publication No. 2002-197179 discloses an intermediary service system for bundled advertisement sending business. The intermediary service system disclosed in Japanese Unexamined Patent Publication No. 2002-197179 introduces a plurality of database owning companies owning customer databases to an advertiser company desiring to distribute an advertisement to customers of another company who meet needs. The customer databases owned by the plurality of database owning companies manage direct sales channels to their own customers or advertisement channels to their own customers. According to the intermediary service system disclosed in Japanese Unexamined Patent Publication No. 2002-197179, an advertiser company can deliver an advertisement of its own service to a customer suitable as a target of the advertisement.

### SUMMARY OF THE INVENTION

By the way, when the type (advertiser) of an advertising leaflet to be bundled is changed for each regular home-delivery member, it is assumed that the operation at the time of sending products becomes complicated. Therefore, it is general to perform an operation of uniformly bundling the same type of advertising leaflets for all members of the EC business operator. However, with such an operation, the minimum number of advertising leaflets that the advertiser requests to bundle becomes the same number as the number of destinations of the products that the EC business operator sends. Therefore, even when there is a member who is not targeted by the advertiser among the members of the EC business operator, the advertiser needs to prepare an advertising leaflet for the member. That is, the minimum fee for using the bundled advertising service becomes high.

In addition, the advertiser needs to prepare in advance a printed material of the advertising leaflet to be requested to be bundled, and send the printed material to a distribution base or the like of the EC business operator. However, the quantity of products or the like to be sent from the EC business operator to the members is not always uniform, and usually varies. Therefore, in order to prevent the shortage of advertising leaflets, the advertiser has been required to take measures such as preparing a large quantity of printed materials including spare ones.

The present invention has been devised in order to solve the above-described problems. An object of the present invention is to enable an advertiser to place an advertisement to an appropriate target customer, and to reduce time and labor required for bundling an advertising leaflet.

A bundled advertising service providing system according to an aspect of the present invention includes a platform providing apparatus that provides a consignor and an advertiser with a platform for a bundled advertising service for bundling an advertising leaflet in a package. The platform providing apparatus includes a hardware processor. The hardware processor selects, as an advertising leaflet to be bundled, an advertising leaflet with a high reward set for attribute information of a customer targeted by the advertiser that requests to bundle the advertising leaflet in the package, based on the attribute information of the customer to whom the package is to be sent. The hardware processor outputs, to a printing apparatus, an instruction to print document data of the selected advertising leaflet.

### BRIEF DESCRIPTION OF THE DRAWINGS

The advantages and features provided by one or more embodiments of the invention will become more fully understand from the detailed description given hereinbelow and the appended drawings which are given by way of illustration only, and thus are not intended as a definition of the limits of the present invention.

FIG. 1 is a diagram illustrating an example of a configuration of a bundled advertising service providing system according to an embodiment of the present invention;

FIG. 2 is a diagram illustrating an example of a configuration of consignor information according to an embodiment of the present invention;

FIG. 3 is a diagram illustrating an example of a personalized leaflet making format according to an embodiment of the present invention;

FIG. 4 is a diagram illustrating an example of a configuration of personalized leaflet making information according to an embodiment of the present invention;

FIG. 5 is a diagram illustrating an example of a configuration of advertiser information according to an embodiment of the present invention;

FIG. 6 is a diagram illustrating an example of a configuration of advertisement information according to an embodiment of the present invention;

FIG. 7 is a diagram illustrating an example of a configuration of package customer correspondence information according to an embodiment of the present invention;

FIG. 8 is a diagram illustrating an example of a process of selecting an advertising leaflet, which is to be bundled, by an advertising leaflet maker according to an embodiment of the present invention;

FIGS. 9A and 9B are diagrams illustrating examples of a configuration of package advertisement correspondence information according to an embodiment of the present invention;

FIG. 10 is a sequence diagram illustrating an example of a procedure of a process of registering information transmitted from a consignor terminal apparatus in a platform providing server according to an embodiment of the present invention;

FIG. 11 is a sequence diagram illustrating an example of a procedure of a process of registering information transmitted from an advertiser terminal apparatus in the platform providing server according to an embodiment of the present invention;

FIG. 12 is a sequence diagram illustrating an example of a procedure of a bundled advertising service providing process by the bundled advertising service providing system according to an embodiment of the present invention;

FIG. 13 is a flowchart illustrating an example of a procedure of a QR code (registered trademark) addition process performed in the bundled advertising service providing process according to an embodiment of the present invention; and

FIGS. 14A and 14B are diagrams illustrating examples of an image scale according to a modification example of the present invention.

### DETAILED DESCRIPTION

Hereinafter, one or more embodiments of the present invention will be described with reference to the drawings. However, the scope of the invention is not limited to the disclosed embodiments.

In this specification and accompanying drawings, constituent elements which have substantially the same functions or structures are denoted by the same reference signs and redundant description of the constituent elements is omitted.

### Configuration of Bundled Advertising Service Providing System

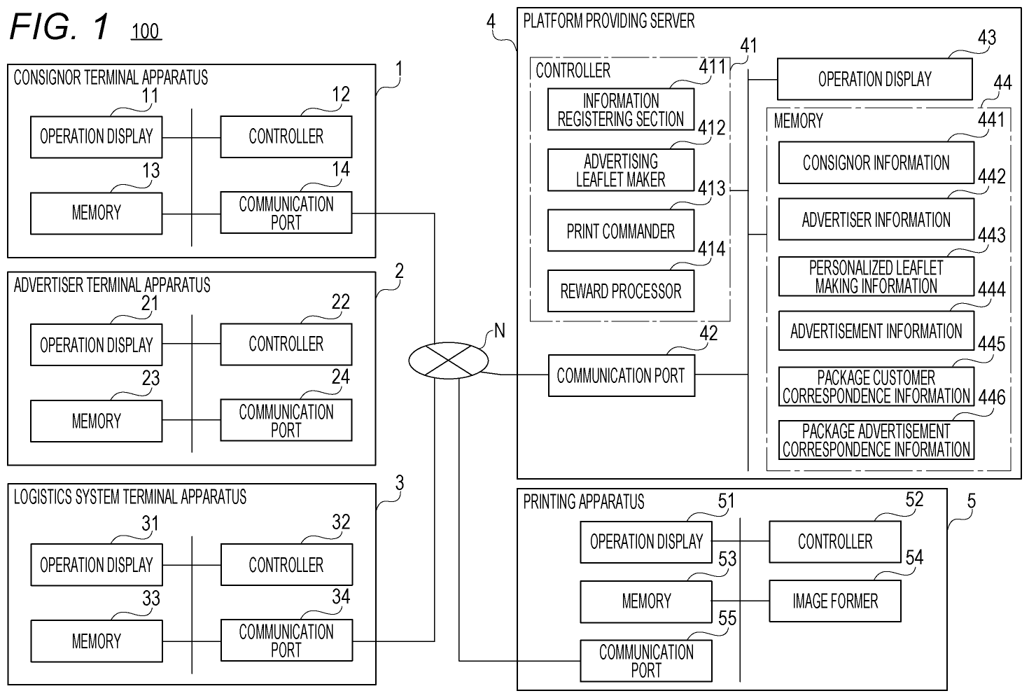

First, a configuration of a bundled advertising service providing system according to an embodiment of the present invention will be described with reference to FIG. 1. FIG. 1 is a diagram illustrating an example of the configuration of the bundled advertising service providing system 100.

As illustrated in FIG. 1, the bundled advertising service providing system 100 includes a consignor terminal apparatus 1, an advertiser terminal apparatus 2, a logistics system terminal apparatus 3, a platform providing server 4 (an example of a platform providing apparatus), and a printing apparatus 5. These apparatuses constituting the bundled advertising service providing system 100 are communicably connected to each other via a network N.

The consignor terminal apparatus 1 is a terminal apparatus used by a consignor that is an EC business operator having a regular home-delivery member. The consignor provides, to an advertiser, a bundled advertising service for bundling an advertising leaflet of the advertiser in a package to be sent to a customer of a consignor company. In addition, the consignor requests the platform providing server 4 to make a personalized leaflet (an example of an advertising leaflet for a consignor) to be bundled together with a product or the like to be sent to the regular home-delivery member of the consignor company.

The advertiser terminal apparatus 2 is a terminal apparatus used by the advertiser. The advertiser uses the bundled advertising service to have its own advertising leaflet bundled in the package that the consignor sends to the member. The advertiser sets the amount of a reward for attribute information of the customer targeted by an advertiser company.

Next, when the advertising leaflet of the advertiser company is bundled in the package sent to the customer of the consignor having the attribute information associated with the reward, the advertiser pays the reward set for the attribute information to the consignor.

The logistics system terminal apparatus 3 is a terminal apparatus used in a logistics system (hereinafter, referred to as a “logistics system”) that performs shipping and delivery of a package of the consignor, that is, a product or the like to be sent to the regular home-delivery member. Although the printing apparatus 5 is arranged in the logistics system terminal apparatus 3, the logistics system terminal apparatus 3 and the printing apparatus 5 are illustrated as being separated from each other in FIG. 1. The printing apparatus 5 prints the personalized leaflet for the consignor and the advertising leaflet of the advertiser to be bundled in the package based on a print instruction transmitted from the platform providing server 4 before the package of the consignor is sent.

The platform providing server 4 is a server operated by a company that provides the advertiser and the consignor with a platform for the bundled advertising service. The platform providing server 4 provides, as the service platform, a user interface (UI) or the like for inputting information necessary for implementing the bundled advertising service. The service platform is provided in, for example, a cloud environment or the like.

The platform providing server 4 makes the personalized leaflet for the consignor. Furthermore, the platform providing server 4 selects an advertising leaflet provided by the advertiser and to be bundled in the package to be sent from the consignor. More specifically, based on the attribute information of the customer to whom the package to be sent is to be sent, the platform providing server 4 selects, as the leaflet to be bundled in the package, an advertising leaflet with the highest reward set by the advertiser. Next, the platform providing server 4 transmits document data of the personalized leaflet for the consignor and document data of the selected advertising leaflet of the advertiser to the printing apparatus 5, and instructs the printing apparatus 5 to print the document data.

Further, the platform providing server 4 performs a process of charging the advertiser for the amount of money corresponding to the reward associated with the advertising leaflet bundled in the shipped package, and a process of paying the amount of money corresponding to the reward received from the advertiser to the consignor.

### Consignor Terminal Apparatus

The consignor terminal apparatus 1 includes an operation display 11, a controller 12, a memory 13, and a communication port 14.

The operation display 11 includes a display including a liquid crystal panel or the like, and an operation input part including a button or the like. Note that the display and the operation input part may be integrally formed as a touch screen. The operation display 11 generates an operation signal indicating details of an operation input to the operation input part by a user, and supplies the operation signal to the controller 12.

The controller 12 includes, for example, a central processing unit (CPU), a random access memory (RAM), a read only memory (ROM), and the like (all of which are not illustrated), and controls an operation of each of the sections constituting the consignor terminal apparatus 1. The CPU reads, from the ROM, a program code of software that implements each function according to the present embodiment, develops the program code in the RAM, and executes the program code. The controller 12 is implemented by a hardware processor.

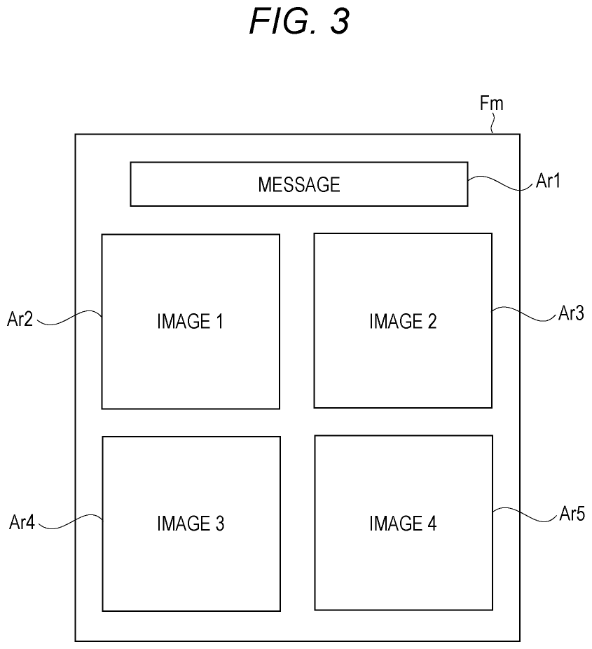

The controller 12 of the consignor terminal apparatus 1 controls the operation display 21 to display a screen for registering, for example, information regarding the consignor, information of a personalized leaflet making format Fm (see FIG. 3), information of a logical expression for selecting an advertisement to be published on the personalized leaflet, and the like. The controller 12 also controls to transmit various information input through the operation display 11 to the platform providing server 4 through the communication port 14.

Note that the controller 12 may include a processing device such as a micro-processing unit (MPU) instead of the CPU. Variables, parameters, and the like generated during arithmetic processing are temporarily written in the RAM.

The memory 13 is a nonvolatile storage or the like. As the nonvolatile storage, for example, a hard disk drive (HDD), a solid state drive (SSD), a flexible disk, an optical disc, a magneto-optical disc, a CD-ROM, a CD-R, a nonvolatile memory card, or the like can be used. An operating system (OS), various parameters, a program for causing the consignor terminal apparatus 1 to function, and the like are recorded in the nonvolatile storage. The program may be stored in the ROM.

The program is stored in the form of a computer-readable program code, and the CPU sequentially executes operations in accordance with the program code. That is, the ROM or the memory 13 is used as an example of a non-transitory recording medium storing a computer-readable program to be executed by a computer.

For example, a network interface card (NIC) or the like is used as the communication port 14. The communication port 14 can transmit and receive various types of data to and from the platform providing server 4 via the network N.

### Advertiser Terminal Apparatus

The advertiser terminal apparatus 2 includes an operation display 21, a controller 22, a memory 23, and a communication port 24. Hardware functions of the operation display 21, the controller 22, the memory 23, and the communication port 24 are the same as those of the operation display 11, the controller 12, the memory 13, and the communication port 14 included in the consignor terminal apparatus 1, respectively, and thus redundant description will be omitted.

The controller 22 of the advertiser terminal apparatus 2 controls the operation display 11 to display, for example, a screen for registering various information such as information regarding the advertiser, document data of an advertising leaflet, a condition for bundling the advertising leaflet, and reward information. The controller 22 also controls to transmit various information input through the operation display 21 to the platform providing server 4 through the communication port 24. The controller 22 is implemented by a hardware processor.

### Logistics System Terminal Apparatus

The logistics system terminal apparatus 3 includes an operation display 31, a controller 32, a memory 33, and a communication port 34. Hardware functions of the operation display 31, the controller 32, the memory 33, and the communication port 34 are the same as those of the operation display 11, the controller 12, the memory 13, and the communication port 14 included in the consignor terminal apparatus 1, respectively, and thus redundant description is omitted.

The controller 32 of the logistics system terminal apparatus 3 controls the operation display 31 to display a screen for inputting a management number and the like of a package scheduled to be shipped, and controls to transmit information input through the operation display 31 to the platform providing server 4 through the communication port 34. The controller 32 is implemented by a hardware processor.

### Platform Providing Server

The platform providing server 4 includes a controller 41, a communication port 42, an operation display 43, and a memory 44. Hardware functions of the controller 41, the communication port 42, the operation display 43, and the memory 44 are the same as those of the controller 12, the communication port 14, the operation display 11, and the memory 13 included in the consignor terminal apparatus 1, respectively, and thus redundant description will be omitted.

The controller 41 of the platform providing server 4 includes an information registering section 411, an advertising leaflet maker 412, a print commander 413, and a reward processor 414. The controller 41, and the information registering section 411, the advertising leaflet maker 412, the print commander 413, and the reward processor 414 of the controller 41 are implemented by a hardware processor.

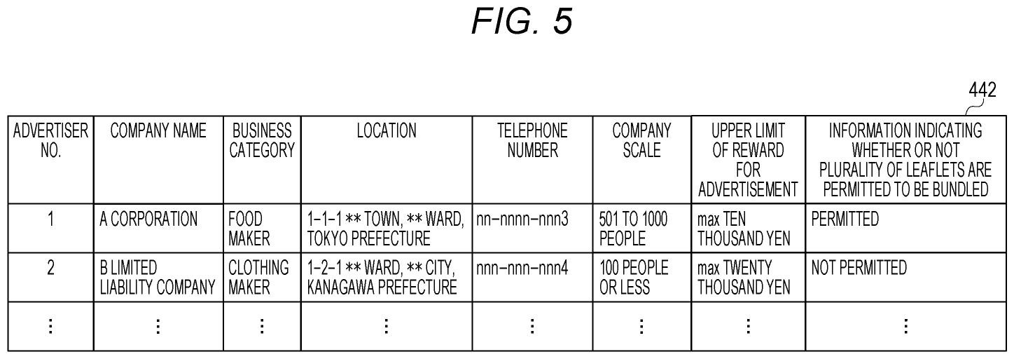

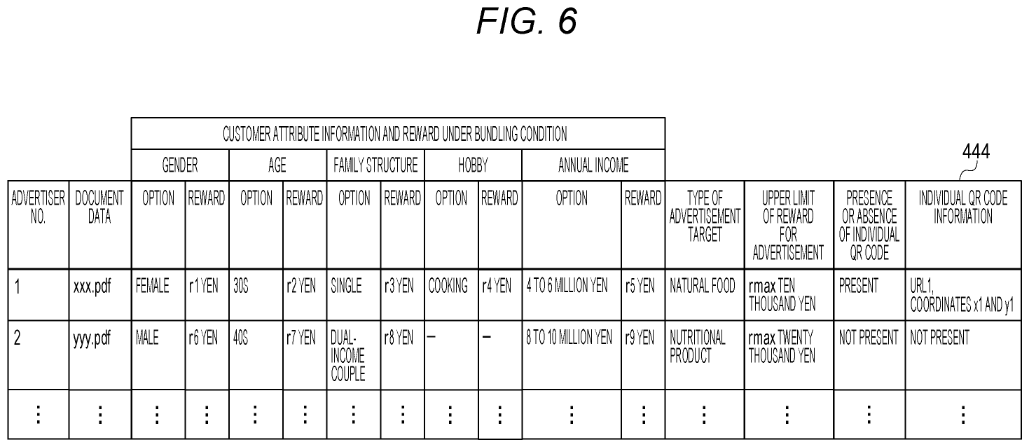

The information registering section 411 registers information regarding the advertiser transmitted from the advertiser terminal apparatus 2 in the memory 44 as advertiser information 442. In addition, the information registering section 411 registers the document data of the advertising leaflet, the condition for bundling the advertising leaflet, the reward information, and the like transmitted from the advertiser terminal apparatus 2 in the memory 44 as advertisement information 444. The advertiser information 442 will be described in detail later with reference to FIG. 5, and the advertisement information 444 will be described in detail later with reference to FIG. 6.

In addition, the information registering section 411 analyzes the content of the document data of the advertising leaflet transmitted from the advertiser terminal apparatus 2, and determines whether or not the product, service, or the like set as an advertisement target is appropriate. When the information registering section 411 determines that the product, service, or the like is appropriate, the information registering section 411 registers the document data in the memory 44, and transmits a notification of the completion of the registration to the advertiser terminal apparatus 2 through the communication port 42. On the other hand, when the information registering section 411 determines that the product, service, or the like is not appropriate, the information registering section 411 does not register the document data in the memory 44, and transmits a notification indicating that the registration is not allowed to the advertiser terminal apparatus 2 through the communication port 42. The information registering section 411 can describe the reason why the registration is not allowed in the notification indicating that the registration is not allowed.

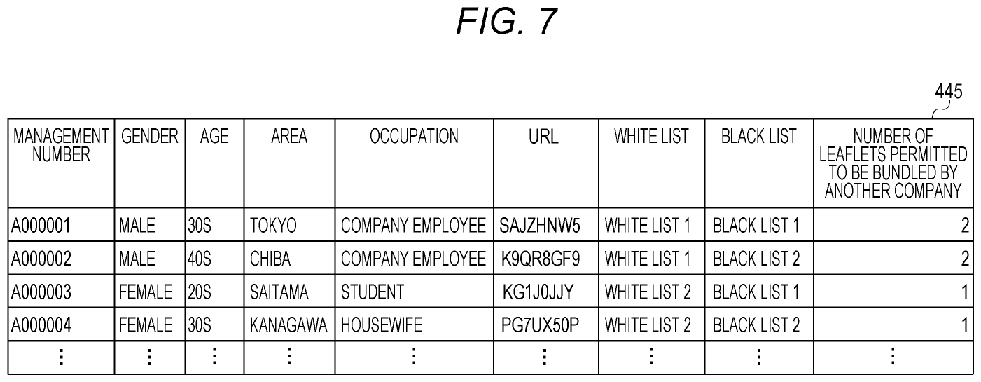

The advertising leaflet maker 412 (an example of an advertising leaflet processor) stores, to the memory 44, the management number of the package scheduled to be sent, which is transmitted from the consignor terminal apparatus 1, and the attribute information of the customer to whom the package is to be sent in association with each other as package customer correspondence information 445. In the package customer correspondence information 445, the attribute information of the customer is set, and information of a white list and a black list for selecting (filtering) an advertiser's advertising leaflet to be bundled in the package is also set. The package customer correspondence information 445 will be described in detail later with reference to FIG. 7.

In addition, the advertising leaflet maker 412 selects candidates for the advertiser's advertising leaflet to be bundled in the package based on the information of the white list and the black list described in the package customer correspondence information 445. Furthermore, based on the bundling condition set in the advertisement information 444 stored in the memory 44, the advertising leaflet maker 412 selects, from among the selected candidates, an advertising leaflet with the highest reward, using a logical expression described in the condition for bundling the advertising leaflet.

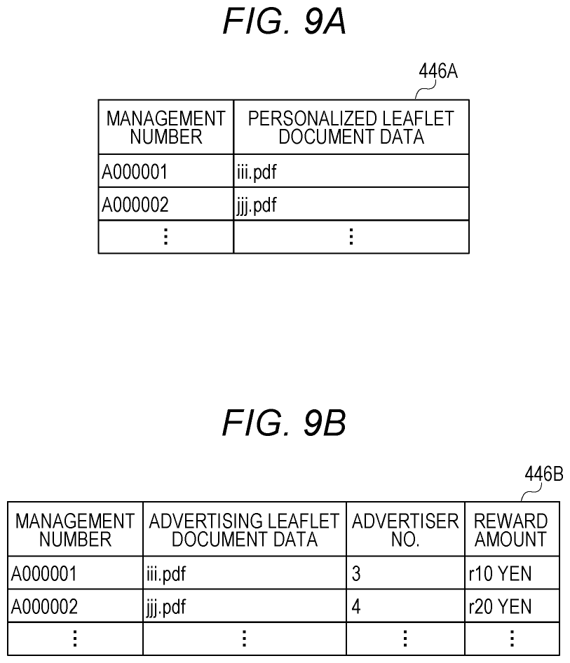

Then, the advertising leaflet maker 412 stores, to the memory 44, document data of the selected advertising leaflet, the information of the advertiser of the advertisement and information of the amount of a reward for the advertisement as package advertisement correspondence information 446B in association with the management number of the package. The package advertisement correspondence information 446B will be described in detail later with reference to FIG. 9.

Further, the advertising leaflet maker 412 makes the personalized leaflet for the consignor by using details of settings for the personalized leaflet system making format Fm (sec FIG. 3) based on the customer attribute information associated with the management number of the package in the package customer correspondence information 445. Next, the advertising leaflet maker 412 stores, to the memory 44, the generated document data (hereinafter, also referred to as “personalized leaflet document data”) of the personalized leaflet and the management number of the package scheduled to be sent in association with each other as package advertisement correspondence information 446A. The package advertisement correspondence information 446A will be described in detail later with reference to FIG. 9. In the following description, the package advertisement correspondence information 446A and 446B are also collectively referred to as “package advertisement correspondence information 446”.

The print commander 413 extracts, from the package advertisement correspondence information 446A, the personalized leaflet document data corresponding to the management number of the package scheduled to be sent, and extracts the advertising leaflet document data from the package advertisement correspondence information 446B. Then, the print commander 413 transmits the extracted document data to the printing apparatus 5 through the communication port 42 and causes the printing apparatus 5 to print the document data.

The reward processor 414 transmits, to the advertiser terminal apparatus 2, information indicating the reward associated with the advertising leaflet bundled in the package shipped from the logistics system, thereby charging the advertiser the amount of money corresponding to the reward. Further, the reward processor 414 pays the amount of money corresponding to the reward received from the advertiser to the consignor.

In the memory 44, consignor information 441, the advertiser information 442, personalized leaflet making information 443, the advertisement information 444, the package customer correspondence information 445, and the package advertisement correspondence information 446 (package advertisement correspondence information 446A and package advertisement correspondence information 446B) are stored.

### Printing Apparatus

The printing apparatus 5 is an image forming apparatus arranged in the logistics system and includes an operation display 51, a controller 52, a memory 53, an image former 54, and a communication port 55. Hardware functions of the operation display 51, the controller 52, the memory 53, and the communication port 55 are the same as those of the operation display 11, the controller 12, the memory 13, and the communication port 14 included in the consignor terminal apparatus 1, respectively, and thus redundant description will be omitted. The controller 52 is implemented by a hardware processor.

The image former 54 forms an image on a sheet by an image forming method such as an electrophotographic method. When the communication port 55 of the printing apparatus 5 receives a print instruction and the document data from the platform providing server 4, the image former 54 forms an image based on the personalized leaflet or the advertising leaflet document data on a sheet, that is, outputs the personalized leaflet or the advertising leaflet. The image forming method of the image former 54 is not limited to the electrophotographic method, and may be another method such as an inkjet method.

### Information Registered by Consignor

Next, information registered in the platform providing server 4 by the consignor via the consignor terminal apparatus 1 will be described. The information registered in the platform providing server 4 by the consignor includes the consignor information 441, the personalized leaflet making format Fm, and the personalized leaflet making information 443.

### Consignor Information

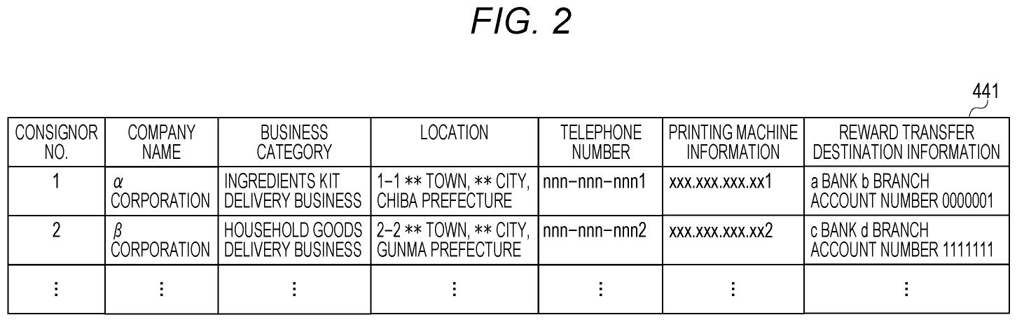

FIG. 2 is a diagram illustrating an example of a configuration of the consignor information 441. As illustrated in FIG. 2, the consignor information 441 includes items of “consignor No.”, “company name”, “business category”, “location”, “telephone number”, “printing machine information”, and “reward transfer destination information”.

In the item of “consignor No.”, a number as an identifier assigned to each consignor is stored. In the item of “company name”, the company name of the consignor is stored. In the item of “business category”, the business category of the consignor is stored. In the item of “location”, an address or the like of a consignor company is stored as information indicating the location of the consignor company. In the item of “telephone number”, a telephone number of the consignor company is stored.

In “printing machine information”, information such as an address of a printing machine is stored. Information such as the model name of the printing machine may be stored in the printing machine information. In “reward transfer destination information”, information such as an account number of a transfer destination of a reward to be paid from the advertiser is stored.

### Personalized Leaflet Making Format

FIG. 3 is a diagram illustrating an example of the personalized leaflet making format Fm. The personalized leaflet is an advertising leaflet of merchandise (a product or a service) of the consignor to the customer (periodic home-delivery member) of the consignor. In the example illustrated in FIG. 3, the personalized leaflet making format Fm is provided with five areas Ar1 to Ar5.

The area Ar1 is an area in which a message (text) is stored. In the area Ar1, for example, a font size of the text, a type of font, information of a field of a list (not illustrated) in which the text is stored, and the like are defined. It is assumed that text data and image data are registered in a list (not illustrated) separately from the format Fm and are transmitted from the consignor terminal apparatus 1 to the platform providing server 4.

The areas Ar2 to Ar5 are areas in which image data (data of images 1 to 4) of an advertisement is stored. Which advertisement (image data thereof) is embedded in which area is determined by the advertising leaflet maker 412 based on the content described in the personalized leaflet making information 443 transmitted from the consignor terminal apparatus 1.

### Personalized Leaflet Making Information

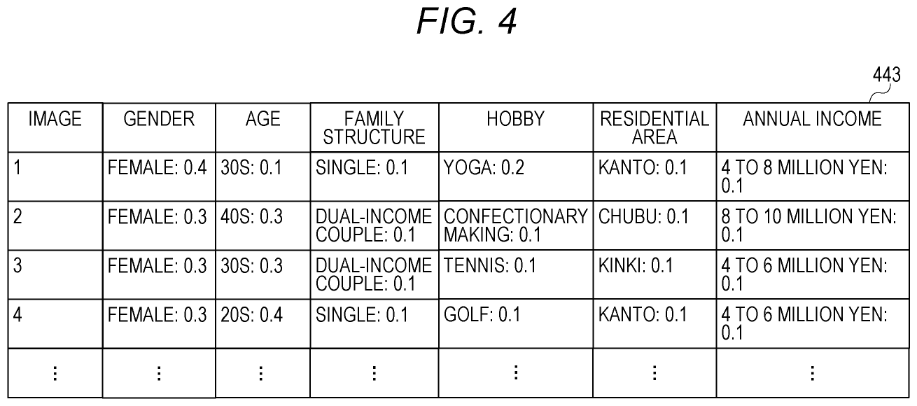

Next, the personalized leaflet making information 443 will be described with reference to FIG. 4.

FIG. 4 is a diagram illustrating an example of a configuration of the personalized leaflet making information 443.

As illustrated in FIG. 4, the personalized leaflet making information 443 includes items of “image”, “gender”, “age”, “family structure”, “hobby”, “residential area”, and “annual income”.

In the item of “image”, numbers identifying the images 1 to 4 in the personalized leaflet making format Fm (see FIG. 3) are stored. In the personalized leaflet making information 443, information such as a logical expression for advertisement selection is set for the advertisement of the respective images 1 to 4 stored in the respective areas Ar of the advertising leaflet making format Fm. In the example illustrated in FIG. 4, weighting information for the attribute information of the customer targeted for the advertisement is set as the logical expression for advertisement selection or the like.

In the item of “gender”, information of the gender of the customer and a corresponding weighting value (for example, 0.4) are stored, and in the item of “age”, information of the age of the customer and a corresponding weighting value (for example, 0.1) are stored. Information indicating the family structure of the customer, such as “single” and “dual-income couple”, and a value (e.g., 0.1) of a corresponding weighting value are stored in information of the “family structure”, and information indicating a hobby of the customer and a value (e.g., 0.2) of a corresponding weighting value are stored in the item of “hobby”. In the item of “residential area”, information of the residential area of the customer, such as “Kanto” or “Chubu”, and a corresponding weighting value (for example, 0.1) are stored, and in the item of the “annual income”, information indicating the annual income of the customer and a corresponding weighting value (for example, 0.1) are stored.

The advertising leaflet maker 412 of the platform providing server 4 selects the advertisements to be assigned to the images 1 to 4 based on the weighting values set in the personalized leaflet making information 443. According to the personalized leaflet making information 443 illustrated in FIG. 4, the advertising leaflet maker 412 assigns, to the “image 1” of the advertising leaflet making format Fm, an image of an advertisement targeted for a customer having attribute information indicating that gender is female, age is in the 30s, a family structure is single, a hobby is yoga, a residential area is Kanto, and annual income is 4 to 8 million yen.

Such personalized leaflet making information 443 is provided for each item of merchandise handled by the consignor or for each customer segment. Then, the advertising leaflet maker 412 selects the appropriate personalized leaflet making information 443 according to the attribute information of the customer to whom the package is to be sent. Further, the advertising leaflet maker 412 selects an image of an advertisement to be assigned to the advertising leaflet making format Fm based on the selected personalized leaflet making information 443. Thus, the advertising leaflet maker 412 can generate an advertisement personalized for a customer who is a regular home-delivery member of the consignor.

The personalized leaflet making information 443 illustrated in FIG. 4 may be set not in units of images (areas) but in units of pages. In a case where the personalized leaflet making information 443 is set in units of pages, and there are a plurality of image (advertisement) embedding areas in a page, the advertising leaflet maker 412 can select images of advertisements corresponding to the number of areas, for example, in order from an advertisement having the highest added value of weighting.

Furthermore, the setting items of the personalized leaflet making information 443 illustrated in FIG. 4 are merely examples, and the personalized leaflet making information 443 may include information other than these items.

Further, the advertising leaflet maker 412 may select an image to be assigned to the advertising leaflet making format Fm by using a learning model or the like generated by a machine learning method such as a decision tree or a random forest instead of the logical expression for image (advertisement) selection.

In addition, in the advertising leaflet making format Fm, information of a QR code (hereinafter, referred to as an “individual QR code”) for measuring a reaction rate (effect) of the customer to the personalized leaflet may be defined according to a desire of the consignor. The QR code is an example of a two-dimensional code.

When desiring to embed an individual QR code, the consignor designates a position where the individual QR code is to be embedded in the advertising leaflet making format Fm. When the advertiser wants to grasp only information indicating whether the customer reacts, the advertiser registers a URL (Uniform Resource Locator) serving as a base to be fixedly used. As the URL, a URL (an example of an address) or the like of a landing page which is opened when the user selects a link is set.

When an URL of a transition destination is desired to be changed for each customer, the consignor can change a variable parameter following a fixed URL for each customer. For example, in URLs in the following first example, since “http://example.com” is a fixed part, the consignor can set parameters such as “&A0001” and “&A0002” according to the customer.

### First Example

http://example.com&A0001
http://example.com&A0002

Furthermore, when the consignor wants to change the URL itself of the transition destination for each customer, the consignor does not set the fixed URL, but sets a URL corresponding to the customer in a list to be separately sent to the platform providing server 4, or designates only a parameter part in the advertising leaflet making format Fm. The following second example indicates an example of an individual URL set according to a customer. In the following second example, “example1” in an URL is a parameter provided for a customer A, and “example2” in an URL is a parameter provided for a customer B.

### Second Example

http://example1.com
http://example2.com

By setting the individual QR code and acquiring reading information of the individual QR code by the customer, that is, information of access to the QR code landing page, the platform providing server 4 can acquire information regarding the reaction by the customer of the consignor to the personalized leaflet. Next, the platform providing server 4 can transmit the grasped information to the consignor. That is, the platform providing server 4 can provide the bundled advertising service having a high added value to the consignor. Thus, the satisfaction of the existing customer who uses the bundled advertising service can be maintained at a high level, and the acquisition of a new customer can be expected.

Note that although the example in which the QR code is provided for the measurement of the reaction rate (effect) of the customer to the personalized leaflet has been described in the present embodiment, the present invention is not limited thereto. Another medium such as a sticker type IC tag or information may be used as long as the medium or the information can be read by a portable terminal or the like carried by the customer and information such as a URL can be embedded in the medium or the information.

### Information Registered by Advertiser

Next, information registered in the platform providing server 4 by the advertiser via the advertiser terminal apparatus 2 (see FIG. 1) will be described. The information registered in the platform providing server 4 by the advertiser includes the advertiser information 442, the advertisement information 444, and the package advertisement correspondence information 446B.

### Advertiser Information

FIG. 5 is a diagram illustrating an example of a configuration of the advertiser information 442. As illustrated in FIG. 5, the advertiser information 442 includes items of “advertiser No.”, “company name”, “business category”, “location”, “telephone number”, “company scale”, “upper limit of reward for advertisement”, and “information indicating whether or not plurality of leaflets are permitted to be bundled”.

In the item of “advertiser No.”, a number as an identifier assigned to each advertiser is stored. In the item of “company name”, the company name of the advertiser is stored. In the item of “business category”, the business category of the advertiser is stored. In the item of “location”, an address or the like of an advertiser company is stored as information indicating the location of the advertiser company. In the item of “telephone number”, a telephone number of the advertiser company is stored.

In the item of “company scale”, as information indicating the scale of the advertiser company, information of the number of employees or the like is stored. As the information indicating the company scale, information of a sales amount of the company or the like may be stored.

In the item of “upper limit of reward for advertisement”, an upper limit value of a monthly reward to be paid to the consignor as a reward for an advertisement is set. When the reward reaches the upper limit set in the “upper limit of reward for advertisement”, document data of the advertiser is excluded from advertising leaflet bidding in that month. That is, the document data is excluded from candidates for an advertising leaflet to be selected by the advertising leaflet maker 412. Note that the unit in which the upper limit of the reward for advertisement is set is not limited to a monthly unit, but may be a weekly unit, a yearly unit, or the like.

In “information indicating whether or not plurality of leaflets are permitted to be bundled”, information indicating whether or not the advertiser permits bundling of a plurality of advertisements for different types of merchandise of the advertiser company for the same delivery destination (customer). When “permitted” is set, a plurality of types of advertisements are sent to one customer from one advertiser. On the other hand, when “not permitted” is set, only one type of advertisement is sent to one customer from one advertiser. In a case where an advertiser that deals with a large number of items of merchandise bundles many types of advertising leaflets for one customer, it is also assumed that impression that the customer receives may become worse. Therefore, the advertiser can prevent the occurrence of a situation in which the impression that the customer receives becomes worse by setting “information indicating whether or not plurality of leaflets are permitted to be bundled” to “not permitted”.

### Advertisement Information

FIG. 6 is a diagram illustrating an example of a configuration of the advertisement information 444. As illustrated in FIG. 6, the advertisement information 444 includes items of “advertisement No.”, “document data”, “customer attribute information and reward under bundling condition”, “type of advertisement target”, “upper limit of reward for advertisement”, “presence or absence of individual QR code”, and “individual QR code information”.

In the item of “advertisement No.”, a number as an identifier assigned to each advertising leaflet is stored. In the item of “document data”, information such as a file name of document data of an advertising leaflet of the advertiser is stored. In the item of “customer attribute information and reward under bundling condition”, information indicating the amount of a reward associated with the customer attribute information is stored.

In the example illustrated in FIG. 6, the item of “customer attribute information and reward under bundling condition” has middle items of “gender”, “age”, “family structure”, “hobby”, and “annual income”. These middle items are merely examples, and the middle items included in the item of “customer attribute information and reward under bundling condition” may include information other than these.

In the item of “gender”, information indicating the gender of the customer targeted by the advertisement and information indicating a set amount of a reward are stored. In the item of “age”, information indicating the age of the customer and information indicating a set amount of a reward are stored. The item of “family structure”, information indicating the family structure of the customer and information indicating a set amount of a reward are stored. In the item of “hobby”, information indicating a hobby of the customer and information indicating a set amount of a reward are stored. In the item of “annual income”, information indicating the annual income of the customer and information indicating a set amount of a reward are stored.

In the item of “type of advertisement target”, information indicating the type of merchandise to be an advertisement target is stored. In the item of “upper limit of reward for advertisement”, information of an upper limit amount of a monthly reward in a case where an upper limit of a reward is set for each advertisement is stored. In the item of “presence or absence of individual QR code”, information indicating whether or not an individual QR code for measuring a reaction of a customer is set for the advertisement is stored. In a case where the individual QR code is set, information of “present” is stored, and in a case where the individual QR code is not set, information of “absent” is stored. In the item of “individual QR code information”, information of a URL of a link destination of the individual QR code, information of a position (coordinates) where the QR code is embedded in an advertising leaflet, and the like are stored in a case where the individual QR code is set.

For example, a file name of document data of an advertising leaflet is indicated as “xxx.pdf” in advertisement information managed in association with “1” in the item of “advertisement No.” of the advertisement information 444. In addition, in the item of “customer attribute information and reward under bundling condition”, a reward of r1 yen is set for “female” in “gender” of the customer attribute, and a reward of r2 yen is set for “30s” in “age”. A reward of r3 yen is set for “single” in “family structure”, a reward of r4 yen is set for “cooking” in “hobby”, and a reward of r5 yen is set for “4 to 6 million yen” in “annual income”.

The amount in “reward” is set to be the highest when the advertisement is sent to the customer targeted for the advertisement. Then, the advertising leaflet maker 412 of the platform providing server 4 selects an advertising leaflet that is targeted for a customer and for which the amount in “reward” is the highest from among a plurality of advertising leaflets managed by the “advertisement No.” as a leaflet to be bundled in a package. Thus, the advertiser can send an advertising leaflet of the advertiser company to the consignor's customer targeted by the advertiser company. Also, the consignor can get a higher amount of reward.

The item of “type of advertisement target” indicates that the type of merchandise that is an advertisement target is “natural food”, and the item of “upper limit of reward for advertisement” indicates that an upper limit of a reward is “rmax1×10,000 yen”. Furthermore, in the item of “presence or absence of individual QR code”, information of “present” is stored, and in the item of “QR code information”, information of a URL (URL1) of an individual QR code and information of coordinates (x1, y1) of the individual QR code are stored.

### Information to be Registered in Platform Providing Server at Stage of Sending Package

Next, information to be registered in the platform providing server 4 at the stage of sending a package will be described. The information to be registered in the platform providing server 4 at the stage of sending the package includes the package customer correspondence information 445 and the package advertisement correspondence information 446.

### Package Customer Correspondence Information

FIG. 7 is a diagram illustrating an example of a configuration of the package customer correspondence information 445. The package customer correspondence information 445 is generated by the advertising leaflet maker 412 of the platform providing server 4 prior to the shipment of the package. In the package customer correspondence information 445, attribute information indicating a customer to whom each package is to be shipped (sent) and filter information are managed in association with a management number assigned to each package. The filter information is information for the advertising leaflet maker 412 to select advertising leaflets to be bundled in a package, and includes a “white list” and a “black list”.

As illustrated in FIG. 7, the package customer correspondence information 445 includes items of “management number”, “gender”, “age”, “area”, “occupation”, “URL”, “white list”, “black list”, and “number of leaflets permitted to be bundled by another company”.

In the item of “management number”, information of a management number assigned to each package scheduled to be sent is stored. In the item of “gender”, information indicating the gender of the customer to whom the package is to be sent is stored. In the item of “age”, information indicating the age of the customer is stored. In the item of “area”, information indicating an area (prefecture) where the customer lives is stored. In the item of “occupation”, information indicating the occupation of the customer is stored.

In the item of “URL”, a parameter of a variable part of a URL of a link destination of an individual QR code in a case where a setting for embedding the individual QR code in an advertising leaflet is made is stored. The “white list” is a list that defines information of a category of merchandise advertised by an advertising leaflet as a condition for the advertising leaflet that is permitted to be bundled in the package. The “blacklist” is a list that defines information of a category of merchandise advertised by an advertising leaflet as a condition for the advertising leaflet that is not permitted to be bundled in the package.

For example, it is assumed that the category of merchandise that is an advertisement target and an advertising leaflet are associated with each other as follows.
Category of “food”: advertising leaflet A, advertising leaflet D, and advertising leaflet F
Category of “aesthetic”: advertising leaflet B, advertising leaflet G, and advertising leaflet I
Category of “cosmetics”: advertising leaflet C, advertising leaflet E, and advertising leaflet H

It is assumed that the category of “food” is set in the “white list” and “none” is set in the “black list”. In this case, the advertising leaflet A, the advertising leaflet D, and the advertising leaflet F associated with the category of “food” are selected as candidates for an advertising leaflet of the other company (advertiser) to be bundled in the package to be sent from the consignor.

On the other hand, it is assumed that “none” is set in the “white list” and “aesthetic” is set in the “black list”. In this case, the advertising leaflet A, the advertising leaflet C, the advertising leaflet D, the advertising leaflet E, the advertising leaflet F, and the advertising leaflet H are selected as candidates for an advertising leaflet of the other company (advertiser) to be bundled in the package to be sent from the consignor. That is, advertising leaflets B, G, and I included in the category of the blacklist are not selected.

Then, the advertising leaflet maker 412 of the platform providing server 4 selects, as a leaflet to be bundled in the package, an advertising leaflet with the highest reward set in the advertisement information 444 (see FIG. 6) from among advertising leaflets remaining as selection targets as a result of filtering using the white list and the black list.

For example, the consignor registers the same category as the category of the merchandise of the consignor company in the blacklist, thereby preventing an advertising leaflet of merchandise of the other company competing with the merchandise of the consignor company from being bundled in a package to be sent to a customer of the consignor company.

In the item of “number of leaflets permitted to be bundled by another company”, information indicating the number of advertising leaflets of the other company (advertiser) permitted to be bundled in the package is set. For a package for which a number of 2 or greater is set in “number of leaflets permitted to be bundled by another company”, the advertising leaflet maker 412 selects advertising leaflets to be bundled in the package for the set number of leaflets.

For example, it is assumed that “not permitted” is set in “information indicating whether or not a plurality of leaflets are permitted to be bundled” of the advertiser information 442 (see FIG. 5). In this case, the advertising leaflet maker 412 excludes an advertising leaflet by an advertiser of an advertising leaflet selected as the first leaflet from selection targets that are the second and subsequent advertising leaflets to be bundled in the package. Then, the advertising leaflet maker 412 selects an advertising leaflet with the next highest reward after the selected advertising leaflet.

The package customer correspondence information 445 illustrated in FIG. 7 is transmitted from the consignor terminal apparatus 1 to the platform providing server 4 at a timing before the package is sent, but the present invention is not limited thereto. Each of the items of “white list”, “black list”, and “number of leaflets permitted to be bundled by another company” in the package customer correspondence information 445 may be registered in advance at a timing such as the time of the registration of the consignor information.

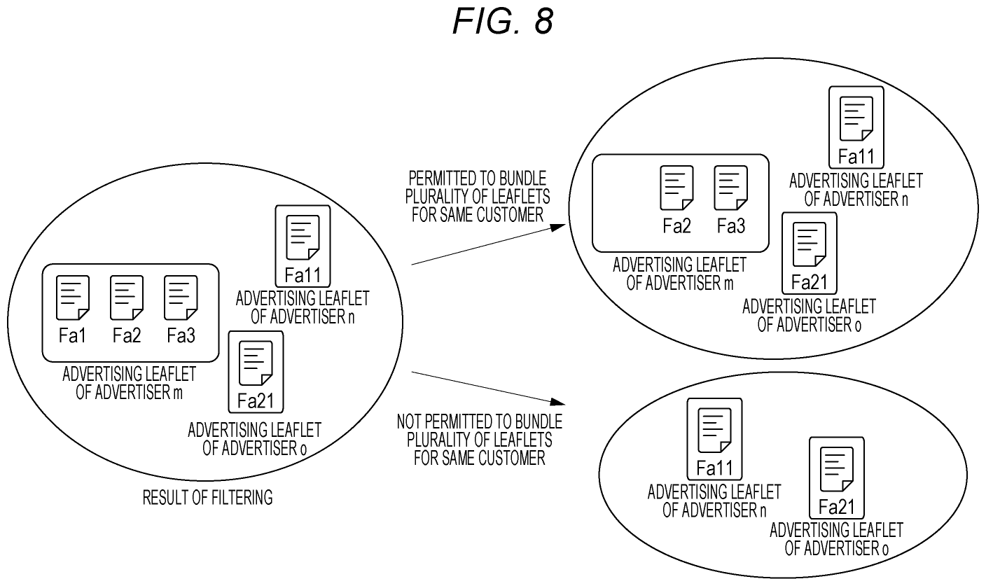

FIG. 8 is a diagram illustrating an example of processing of selecting an advertising leaflet, which is to be bundled, by the advertising leaflet maker 412. The left side of FIG. 8 illustrates an example of an advertising leaflet remaining as a result of being filtered based on the white list and/or the black list. In the example illustrated on the left side of FIG. 8, as a result of the filtering, advertising leaflets Fa1 to Fa3 by an advertiser m, an advertising leaflet Fa11 by an advertiser n, and an advertising leaflet Fa21 by an advertiser o remain as candidates for the advertising leaflet to be bundled in the package. Then, it is assumed that the advertising leaflet Fa1 by the advertiser m is selected by the advertising leaflet maker 412 as an advertising leaflet to be bundled in the package.

In a case where “information indicating whether or not a plurality of leaflets are permitted to be bundled” is set to “permitted” in the advertiser information 442 set by the advertiser m, as illustrated in the upper right of FIG. 8, the advertising leaflets Fa2 and Fa3 of a type different from that of the advertising leaflet Fa1 by the advertiser m are also candidates for selection of a leaflet to be bundled. In addition, the advertising leaflet Fa11 by the other advertiser n and the advertising leaflet Fa21 by the advertiser o are also candidates for selection.

On the other hand, in a case where, in the advertiser information 442 set by the advertiser m, “information indicating whether or not a plurality of leaflets are permitted to be bundled” is set to “not permitted”, as illustrated in the lower right of FIG. 8, the advertisement leaflet Fa2 and the advertisement leaflet Fa3 that are of a type different from that of the advertising leaflet Fa1 by the advertiser m are excluded from candidates for selection of a leaflet to be bundled. Therefore, in the advertiser information 442, document data of an advertising leaflet with a higher reward is selected from the advertising leaflet Fa11 by the other advertiser n and the advertising leaflet Fa21 by the advertiser o.

### Package Advertisement Correspondence Information

FIGS. 9A and 9B are diagrams illustrating examples of a configuration of the package advertisement correspondence information 446. FIG. 9A illustrates an example of the configuration of the package advertisement correspondence information 446A, and FIG. 9B illustrates an example of the configuration of the package advertisement correspondence information 446B.

As illustrated in FIG. 9A, the package advertisement correspondence information 446A includes items of “management number” and “personalized leaflet document data”. In the item of “management number”, information of a management number of a package scheduled to be sent is stored. In the item of “personalized leaflet document data”, a file name of the document data of the personalized leaflet of the consignor associated with the management number of the package or the like is stored.

As illustrated in FIG. 9B, the package advertisement correspondence information 446B includes items of “management number”, “advertising leaflet document data”, “advertiser No.”, and “reward amount”. In the item of “management number”, information of a management number of a package scheduled to be sent is stored. In the item of “advertising leaflet document data”, a file name of advertising leaflet document data associated with the management number of the package or the like is stored.

In the item of “advertiser No.”, an advertisement No. of the advertiser that has made an advertising leaflet is stored. The company name or the like of the advertiser may be stored instead of the advertiser No. In the item of “reward amount”, information indicating the amount of a reward associated with the advertising leaflet (managed in association with the package number) to be bundled in the package is stored.

### Method for Providing Bundled Advertising Service

Next, a method for providing the bundled advertising service by the bundled advertising service providing system 100 according to the present embodiment will be described.

### Information Registration Process by Consignor

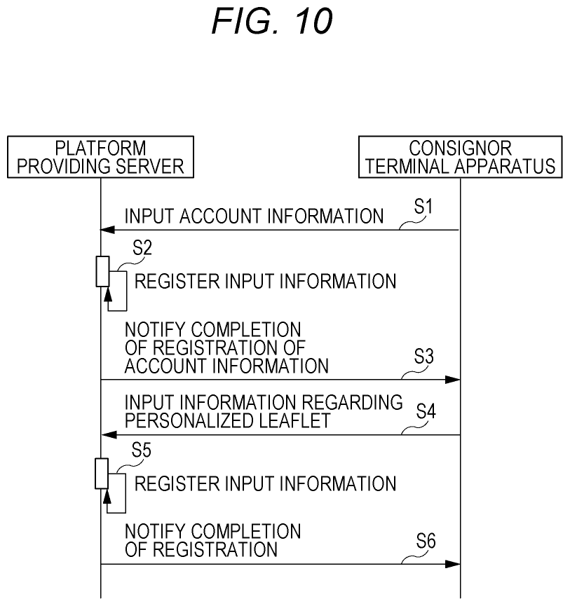

First, an information registration process by the consignor will be described with reference to FIG. 10. FIG. 10 is a sequence diagram illustrating an example of a procedure of a process of registering information transmitted from the consignor terminal apparatus 1 in the platform providing server 4.

First, the consignor operates the operation display 11 (see FIG. 1) of the consignor terminal apparatus 1 to input account information of the consignor company to the service platform provided by the platform providing server 4 (step S1). That is, the account information of the consignor input via the operation display 11 is transmitted to the platform providing server 4 through the communication port 14 based on control by the controller 12 of the consignor terminal apparatus 1.

Next, the information registering section 411 of the platform providing server 4 registers the account information of the consignor input in step S1 as the consignor information 441 (see FIG. 2) in the memory 44 (step S2). Next, the information registering section 411 of the platform providing server 4 transmits a notification indicating completion of the registration of the account information to the consignor terminal apparatus 1 through the communication port 42 (step S3).

Next, the consignor operates the operation display 11 of the consignor terminal apparatus 1 to input information regarding the personalized leaflet of the consignor to the service platform provided by the platform providing server 4 (step S4). The information transmitted from the consignor terminal apparatus 1 to the platform providing server 4 in step S4 includes the personalized leaflet making format Fm (see FIG. 3), an image and a message (text) for advertisement, information indicating a logical expression for selecting an image or text to be inserted in an area defined in the personalized leaflet making format Fm, and the like.

Next, the information registering section 411 of the platform providing server 4 registers the various types of information input in step S4 in the memory 44 (step S5). Specifically, the information registering section 411 of the platform providing server 4 registers the personalized leaflet making format Fm in the memory 44, and registers the information regarding the personalized leaflet as the personalized leaflet making information 443 in the memory 44. Next, the information registering section 411 of the platform providing server 4 transmits a notification indicating completion of the registration of the information regarding the personalized leaflet to the consignor terminal apparatus 1 through the communication port 42 (step S6). After the processing in step S6, the information registration process by the consignor ends.

### Information Registration Process by Advertiser

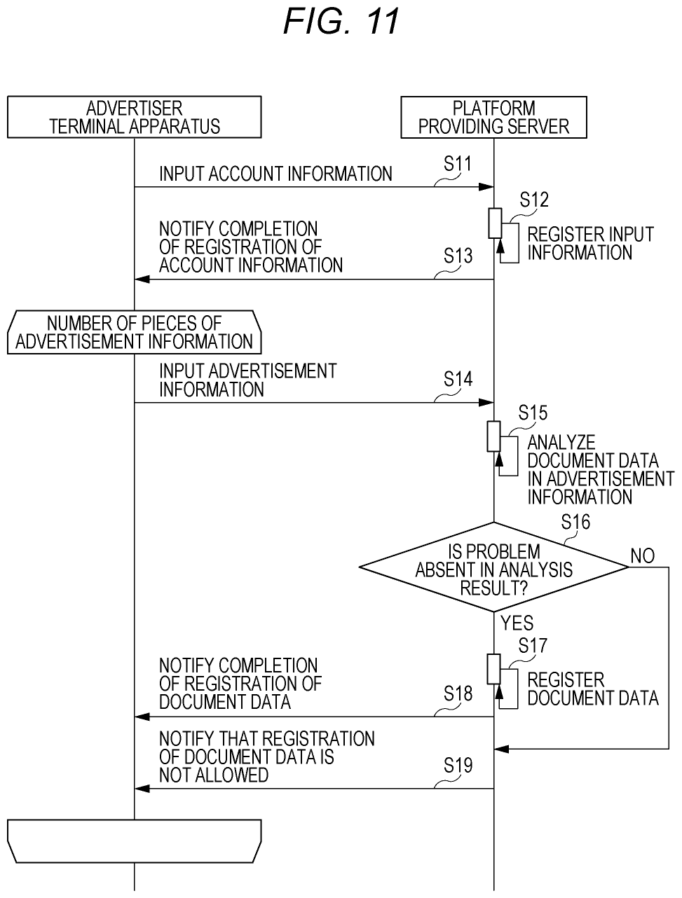

Next, an information registration process by the advertiser will be described with reference to FIG. 11. FIG. 11 is a sequence diagram illustrating an example of a procedure of a process of registering information transmitted from the advertiser terminal apparatus 2 in the platform providing server 4.

First, the advertiser operates the operation display 21 (see FIG. 1) of the advertiser terminal apparatus 2 to input account information of the advertiser company to the service platform provided by the platform providing server 4 (step S11).

Next, the information registering section 411 of the platform providing server 4 registers the account information of the advertiser input in step S11 as the advertiser information 442 (see FIG. 5) (step S12). Next, the information registering section 411 of the platform providing server 4 transmits a notification indicating completion of the registration of the account information to the advertiser terminal apparatus 2 through the communication port 42 (step S13).

Next, the advertiser operates the operation display 21 of the advertiser terminal apparatus 2 to input information regarding the advertisement by the advertiser to the service platform provided by the platform providing server 4 (step S14). The information transmitted from the advertiser terminal apparatus 2 to the platform providing server 4 in step S14 includes the advertising leaflet document data, correspondence information between a condition for bundling the advertising leaflet and a reward, information indicating the upper limit of the reward for the advertisement, information indicating the addition of an individual QR code, and the like.

Next, the information registering section 411 of the platform providing server 4 analyzes the advertising leaflet document data input in step S14 (step S15). Next, the information registering section 411 determines whether or not a problem is absent in a result of the analysis (step S16). In a case where the information registering section 411 determines in step S16 that a problem is absent in a result of the analysis (YES in step S16), the information registering section 411 registers the information regarding the advertisement input in step S14 as the advertisement information 444 (see FIG. 6) in the memory 44 (step S17).

Next, the information registering section 411 transmits a notification indicating completion of the registration of the information regarding the advertisement to the advertiser terminal apparatus 2 through the communication port 42 (step S18). In a case where the information registering section 411 determines in step S16 that a problem is present in a result of the analysis (NO in step S16), the information registering section 411 transmits a notification indicating that the registration of the information regarding the advertisement is not allowed to the advertiser terminal apparatus 2 through the communication port 42 (step S19). The processing from step S14 to step S18 or step S19 is repeatedly performed as many times as the number of types of advertising leaflets required to be made.

### Bundled Advertising Service Providing Process

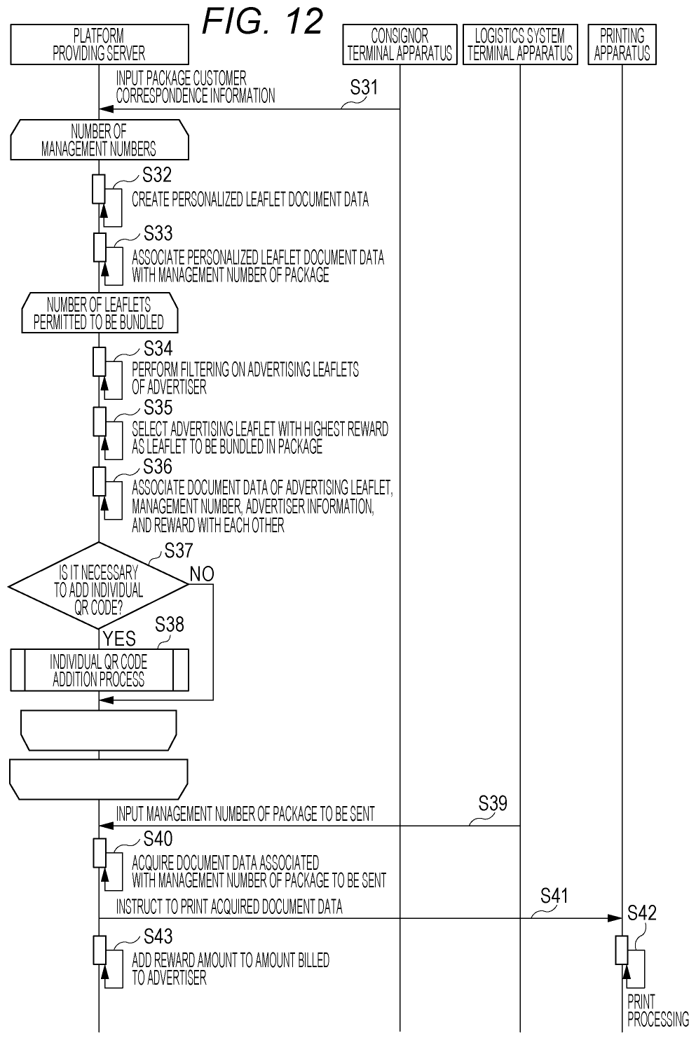

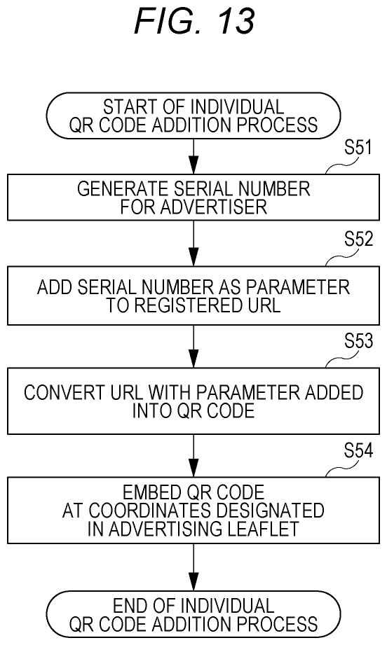

Next, referring to FIGS. 12 and 13, a bundled advertising service providing process by the bundled advertising service providing system 100 will be described. FIG. 12 is a sequence diagram illustrating an example of a procedure of the bundled advertising service providing process by the bundled advertising service providing system 100. FIG. 13 is a flowchart illustrating an example of a procedure of an individual QR code addition process performed in the bundled advertising service providing process.

First, the consignor operates the operation display 11 (see FIG. 1) of the consignor terminal apparatus 1 to input the package customer correspondence information to the service platform provided by the platform providing server 4 (step S31). The package customer correspondence information includes a management number of a package scheduled to be sent, attribute information of a customer to whom the package is to be sent, information of a URL of a link destination of a QR code in a case where the QR code is added to the personalized leaflet, information of the white list and the black list, and information of the number of leaflets permitted to be bundled by the other company. The information input in step S31 is stored as the package customer correspondence information 445 in the memory 44 (see FIG. 7).

Next, the advertising leaflet maker 412 of the platform providing server 4 creates personalized leaflet document data for the consignor using an image and text for advertisement based on the customer attribute information described in the package customer correspondence information 445 and details of settings of the personalized leaflet making information 443 (step S32). Next, the advertising leaflet maker 412 of the platform providing server 4 associates the personalized leaflet document data created in step S32 with the management number of the package scheduled to be sent (step S33). Then, the advertising leaflet maker 412 stores the content associated in step S33 as the package advertisement correspondence information 446A (see FIG. 9) to the memory 44.

The processing in step S32 and step S33 is repeatedly performed as many times as the number of packages scheduled to be sent, that is, the number of management numbers associated with the packages on a one to-one basis.

Next, the advertising leaflet maker 412 performs filtering on advertiser's advertising leaflets to be bundled in the package (step S34). The filtering in step S34 is performed based on the black list and the white list described in the package customer correspondence information 445 input in step S31.

Next, the advertising leaflet maker 412 selects, from among the advertising leaflets filtered in step S34, an advertising leaflet with the highest reward calculated based on the attribute information of the customer to whom the package is to be sent, as an advertising leaflet to be bundled in the package (step S35).

Next, the advertising leaflet maker 412 associates document data of the advertising leaflet selected in step S35, the management number of the package, information of the advertiser that made the advertising leaflet, and information indicating a reward amount for the advertising leaflet with each other (step S36). Then, the advertising leaflet maker 412 stores the associated information as the package advertisement correspondence information 446B to the memory 44.

Next, the advertising leaflet maker 412 determines whether or not it is necessary to add an individual QR code to the advertising leaflet (step S37). The advertising leaflet maker 412 can confirm information indicating whether or not it is necessary to add the individual QR code by referring to the advertisement information 444 (sec FIG. 6). In a case where the advertising leaflet maker 412 determines in step S37 that it is necessary to add the individual QR code (YES in step S37), the advertising leaflet maker 412 performs the QR code addition process of adding a QR code to the advertising leaflet document data (step S38).

On the other hand, in a case where the advertising leaflet maker 412 determines in step S37 that it is not necessary to add the individual QR code (NO in step S37), the advertising leaflet maker 412 does not execute the QR code addition process. The processing from step S34 to step S38 described above is repeatedly performed until the number of advertising leaflets to be bundled in the package reaches the number of leaflets permitted to be bundled in a package by another company defined in the package customer correspondence information 445.

Here, the QR code addition process performed in step S38 will be described with reference to FIG. 13. First, prior to generation of a QR code, the advertising leaflet maker 412 generates a serial number (an example of identification information) for an individual QR code for the advertiser to be used within each of the advertisers (step S51). Next, the advertising leaflet maker 412 adds the serial number generated in step S51 as a parameter to the URL of the individual QR code registered in the advertisement information 444 (step S52). The serial number added as the parameter to the QR code in step S52 is managed in the platform providing server 4 in association with the management number of the package to be sent. More specifically, the serial number is used to manage the QR code URL, information of the customer to whom the package associated with the management number is to be sent, and information of the advertiser of the advertising leaflet in association with each other.

Next, the advertising leaflet maker 412 converts the URL including the parameter added in step S52 into a QR code (step S53). Next, the QR code generated in step S53 is added to coordinates designated in the advertisement information 444 in the advertising leaflet data (step S54). The processing from step S51 to step S54 is repeatedly performed as many times as the number of individual QR codes required to be generated.

By performing the process illustrated in FIG. 13, the controller of the platform providing server 4 can grasp, based on parameters added to the individual QR codes, information regarding the effect of the advertising leaflet, such as which customer has accessed which QR code. Then, the controller of the platform providing server 4 can feed the information regarding the effect of the advertising leaflet back to the advertiser. The advertiser that has received the feedback can determine whether or not the customer who has taken an action for the advertising leaflet is a customer of a customer segment who has actually been the target of the advertisement. Thus, based on the content of the feedback, the advertiser can take measures such as regeneration of an advertising leaflet more appealing to a target customer and review of the condition for bundling the advertising leaflet.

Referring back to FIG. 12, the description is continued. In the stage of sending the package, information indicating the management number of the package to be sent is transmitted from the logistics system terminal apparatus 3 to the platform providing server 4 (step S39). The transmission of the management number in step S39 is performed, for example, based on information or the like obtained by reading a barcode or the like (not illustrated) of the package conveyed on a belt conveyor of the logistics system by a barcode reader of the logistics system. That is, a package number associated with the barcode read by the barcode reader of the logistics system is transmitted from the logistics system terminal apparatus 3 to the platform providing server 4. The timing at which the management number of the package is transmitted from the logistics system terminal apparatus 3 is not limited to this example, and may be a time point at which the management number of the package scheduled to be sent is determined, or the like.

Next, the print commander 413 of the platform providing server 4 acquires the personalized leaflet document data and the advertising leaflet document data associated with the management number transmitted from the logistics system terminal apparatus 3 in step S39 (step S40). The print commander 413 acquires the personalized leaflet document data associated with the management number, based on the content described in the package advertisement correspondence information 446A (see FIG. 9). Further, the print commander 413 acquires the advertising leaflet document data of the advertiser based on the content described in the package advertisement correspondence information 446B.

Next, the print commander 413 instructs the printing apparatus 5 to print the document data (the personalized leaflet document data and the document data of the advertiser) acquired in step S40 (step S41). Next, the image former 54 of the printing apparatus 5 forms an image on a sheet based on the document data instructed to be printed, thereby printing the personalized leaflet and the advertising leaflet (step S42).

Next, the reward processor 414 of the platform providing server 4 performs processing of adding the reward amount associated with the package to the amount billed to the advertiser for the advertising leaflet bundled in the package (step S42). The amount billed to the advertiser includes, in addition to the reward amount, the cost of the sheet for the advertising leaflet, a charge amount (click charge) set per sheet printed by the printing apparatus 5, an advertisement making cost, and the like.

In the above-described embodiment, the advertising leaflet maker 412 of the platform providing server 4 selects, based on the attribute information of the customer to whom the package scheduled to be sent is to be sent, the document data of the advertising leaflet with the highest reward set for the attribute information of the customer targeted by the advertiser, as the leaflet to be bundled in the package. The print commander 413 of the platform providing server 4 outputs, to the printing apparatus 5, an instruction to print the document data of the advertising leaflet selected by the advertising leaflet maker 412.

Thus, the advertising leaflet of the advertiser is bundled in the package to be sent to the consignor's customer who has the attribute information matching the attribute information of the customer targeted by the advertiser. Therefore, the advertiser can send an advertising leaflet to a customer targeted by the advertiser with pinpoint accuracy. That is, according to the present embodiment, the advertiser can place an advertisement to an appropriate target customer. Thus, it is possible to improve the cost effectiveness of the use of the bundled advertising service by the advertiser.

Furthermore, in the above-described embodiment, an instruction to print the advertising leaflet selected by the advertising leaflet maker 412 and associated with the package scheduled to be sent is output from the print commander 413 to the printing apparatus 5. That is, the advertising leaflet associated with the package scheduled to be sent is printed by the printing apparatus 5. Therefore, the advertiser does not need to print and prepare an advertising leaflet in advance or send the printed advertising leaflet to the consignor. Further, according to the present embodiment, the consignor does not need to perform complicated work such as associating the advertising leaflet sent from the advertiser with the package in which the advertising leaflet is to be bundled.

### Modification Examples

### First Modification Example

Although the example in which the advertiser sets the amount of a reward for the customer attribute of the customer to whom the package of the consignor is to be sent has been described in the above-described embodiment, the present invention is not limited thereto. The advertiser may set the amount of a reward for the consignor information. The consignor information includes, for example, information of a customer segment of the consignor, information of merchandise handled by the consignor, and the like.

For example, the consignor registers an image scale indicating an impression of the customer segment, merchandise, or the like of the consignor in the platform providing server 4 in advance via the consignor terminal apparatus 1 (see FIG. 1). Then, the advertiser sets the amount of a reward for information indicated as the image scale. The image scale is a mapping tool of an image, and is obtained by arranging a single color, a color arrangement, words, and the like on a coordinate axis serving as a criterion for determining the image.

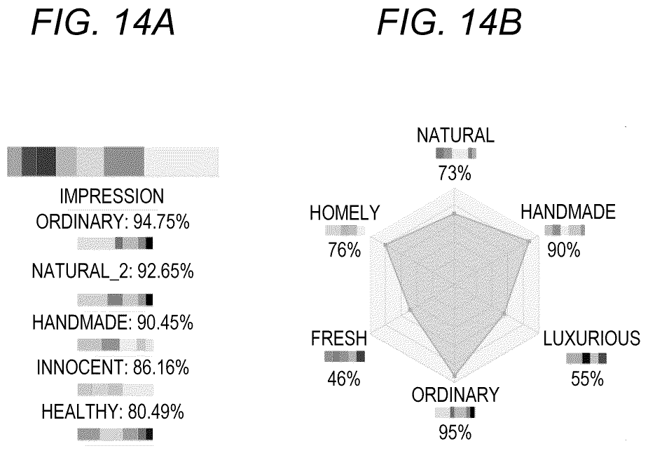

FIGS. 14A and 14B are diagrams illustrating examples of the image scale registered in the platform providing server 4 by the consignor. FIGS. 14A and 14B illustrate data published in schematic explanatory materials (downloadable from the following URL (https://explainablekansei.konicaminolta.com/downloadlist)) of a service called “Explainable-Kansei” provided by Konica Minolta, Inc.

FIG. 14A illustrates an image scale indicating an image of merchandise provided by the consignor or a customer segment of the consignor by multi-color gradation. FIG. 14B illustrates an image scale indicating an image of merchandise provided by the consignor or a customer segment of the consignor by using a radar chart illustrating intensity information of each image. It is assumed that, in the platform providing server 4, the amount of a reward is set for the image scale of the consignor.

The advertiser selects a keyword or the like close to an image desired to be a target of advertisement of the advertiser company via the advertiser terminal apparatus 2, and transmits the selected keyword or the like to the platform providing server 4. Next, the platform providing server 4 selects the consignor associated with the keyword transmitted from the advertiser terminal apparatus 2 as the consignor to bundle the advertising leaflet by the advertiser. Then, the platform providing server 4 transmits a notification of payment of the amount of money corresponding to the reward associated with the image scale to the advertiser terminal apparatus 2, and performs a process of paying the amount of money corresponding to the reward paid by the advertiser to the consignor.

According to the above-described first modification example, the advertiser pays the reward to the consignor via the platform providing server 4, thereby being able to appropriately select the consignor that deals with the merchandise matched with the image which is desired to be the target of the advertisement of the advertiser company. In addition, the consignor can obtain not only the reward set for the attribute information of the customer but also the reward set for the consignor information.

In addition, the platform providing server 4 may use the image scale as a tool in the case of feeding the result of analyzing the advertising leaflet generated by the advertiser back to the advertiser. For example, the platform providing server 4 analyzes a color included in the document data of the advertising leaflet transmitted from the advertiser terminal apparatus 2, and plots a result of the analysis on an image scale. Then, the platform providing server 4 transmits the image scale on which the analysis result is plotted to the advertiser terminal apparatus 2. Thus, the platform providing server 4 can notify the advertiser of feedback information such as whether or not an image (to be given to the customer) included in the advertising leaflet matches an image into which the target customer is classified.

Further, the platform providing server 4 may transmit, to the advertiser terminal apparatus 2, advice or the like for matching the image (to be given to the customer) included in the advertising leaflet with the image into which the customer segment targeted by the consignor is classified. Specifically, the platform providing server 4 can transmit, to the advertiser terminal apparatus 2, advice or the like for moving a position where the image included in the advertising leaflet is plotted to a position where the image into which the customer segment is classified has been plotted.

In addition, the platform providing server 4 may transmit, to the advertiser terminal apparatus 2, ranking information or the like of a point which is conspicuous and easily noticed in the advertisement as feedback to the advertiser. Furthermore, when analyzing that the information that the advertiser wants to draw customer's attention is not published in a conspicuous point or a point that is easy to draw attention in the advertising leaflet created by the advertiser, the platform providing server 4 may transmit advice on improvement of the advertising leaflet or the like to the advertiser terminal apparatus 2. Such a service provided by the platform providing server 4 can increase the number of customers of the company that operates the platform providing server 4.

### Second Modification Example

Furthermore, the platform providing server 4 may provide the consignor with a service for proposing an improvement in the logical expression indicated in the personalized leaflet making information 443 illustrated in FIG. 4, based on a result of analyzing an access log to the individual QR code embedded in the personalized leaflet, or the like.

For example, the platform providing server 4 provides the service platform with a UI for inputting information necessary for providing the improvement proposal service. The information necessary for providing the improvement proposal service includes purchase history information of a customer of the consignor, information of a URL of a landing page of an advertisement that is embedded in a personalized leaflet in the form of an individual QR code, information of an identifier to be assigned to a URL and necessary for analyzing an access log of the URL, and the like.

The controller 41 of the platform providing server 4 registers these pieces of information input by the consignor via the consignor terminal apparatus 1 in a database (not illustrated) in the memory 44 in association with a customer ID. Further, the controller 41 accumulates purchase information of the customer and/or information of access to the landing page of the advertisement by the customer in a database for machine learning as learning data. Then, the controller 41 causes the machine learning to train an algorithm for outputting information of a logical expression in which a purchasing behavior by the customer and/or the number of times of access to the landing page is maximized with respect to the customer information such as the input customer ID.

At the timing when the consignor makes a proposal for switching the logical expression or the like via the consignor terminal apparatus 1, the advertising leaflet maker 412 of the platform providing server 4 transmits information of the improved logical expression in association with the information of the customer segment to the consignor terminal apparatus 1. According to the second modification example, the consignor can generate an advertising leaflet more appealing to a target customer by using the logical expression proposed for improvement by the platform providing server 4, thus promoting the purchasing behavior of the customer. Furthermore, according to the second modification example, since the added value of the bundled advertising service provided by the platform providing server 4 can also be improved, the number of users (consignors and advertisers) of the bundled advertising service can be increased.

When proposing the improved logical expression, the platform providing server 4 may also transmit document data of a personalized leaflet generated based on the logical expression to the consignor terminal apparatus 1. Such a service is provided, and thus the consignor can check the content of the personalized leaflet created based on the improved logical expression.

### Third Modification Example

In addition, in the category set in the “white list” of the package customer correspondence information 445 illustrated in FIG. 7, information indicating whether or not a coupon in an advertising leaflet is present may be set. Such a setting can increase the possibility that the advertising leaflet maker 412 of the platform providing server 4 selects an advertising leaflet with a coupon as a leaflet to be bundled. That is, it is possible to provide an advantage due to the coupon to the customer to whom the package is to be sent. In addition, by increasing the probability that an advertising leaflet with a coupon is bundled, it is possible to increase the number of consignor's customers who feel attractive to the acquisition of the coupon.

In each of the above-described embodiments and modification examples, the configurations of the apparatuses and the system have been described in detail and specifically in order to explain the present invention in an easy-to-understand manner, and the present invention is not necessarily limited to those including all the configurations described above.

Further, control lines or information lines indicated by solid lines in FIG. 2 indicate lines considered to be necessary for description, and do not necessarily indicate all control lines or information lines in a product. Actually, it may be considered that almost all of the components are connected to each other.

Further, in the present specification, the processing steps describing time-series processing include not only the processing performed in a time-series manner according to the described order, but also the processing performed in parallel or individually (for example, parallel processing or processing by an object), which is not necessarily performed in a time-series manner.

What is claimed is:

1. A bundled advertising service providing system comprising:
a platform providing apparatus that provides a consignor and an advertiser with a platform for a bundled advertising service for bundling an advertising leaflet in a package, wherein
the platform providing apparatus includes a hardware processor,
the hardware processor selects, as an advertising leaflet to be bundled, an advertising leaflet with a high reward set for attribute information of a customer targeted by the advertiser that requests to bundle the advertising leaflet in the package, based on the attribute information of the customer to whom the package is to be sent, and
the hardware processor outputs, to a printing apparatus, an instruction to print document data of the selected advertising leaflet.

2. The bundled advertising service providing system according to claim 1, wherein the hardware processor performs processing of transmitting information indicating an amount of money corresponding to the reward set for the advertising leaflet bundled in the package to an advertiser terminal apparatus of the advertiser, and transferring the amount of money based on the reward received from the advertiser to a transfer destination designated by the consignor.

3. The bundled advertising service providing system according to claim 2, wherein
the package scheduled to be sent, the attribute information indicating the customer to which the package is to be sent, and the document data of the selected advertising leaflet are each managed in association with a management number of the package scheduled to be sent, and
the hardware processor outputs, to the printing apparatus, an instruction to print the document data of the advertising leaflet associated with the management number of the package scheduled to be sent.

4. The bundled advertising service providing system according to claim 3, wherein the hardware processor selects the advertising leaflet to be a selection target that is the leaflet to be bundled in the package, based on information regarding merchandise that is permitted to be bundled in the package and information regarding merchandise that is not permitted to be bundled in the package, the information being transmitted in advance from a consignor terminal apparatus of the consignor that sends the package to the customer.

5. The bundled advertising service providing system according to claim 4, wherein the hardware processor selects the advertising leaflet to be bundled in the package based on information indicating whether or not a plurality of types of advertising leaflets by the advertiser for a same customer are permitted to be bundled, the information being transmitted in advance from the advertiser terminal apparatus of the advertiser.

6. The bundled advertising service providing system according to claim 5, wherein the hardware processor converts an address of a landing page of the advertiser that has been transmitted in advance from the advertiser terminal apparatus and has, added as a parameter, identification information of the advertising leaflet into a two-dimensional code, embeds the two-dimensional code in the document data, manages the identification information and the management number in association with each other, and transmits, when detecting access to the landing page by the customer, correspondence information between the identification information and the attribute information of the customer associated with the management number to the advertiser terminal apparatus.

7. The bundled advertising service providing system according to claim 3, wherein the hardware processor generates the advertising leaflet for the consignor to be bundled in the package to be sent to the customer of the consignor, based on the document data of the advertising leaflet for the consignor and information of a format of the advertising leaflet for the consignor, the document data and the information of the format being transmitted from the consignor terminal apparatus of the consignor.

8. The bundled advertising service providing system according to claim 7, wherein
the document data of the advertising leaflet for the consignor includes an image and/or text for advertisement, and
the hardware processor selects the image and/or the text to be inserted into the format of the advertising leaflet for the consignor, based on information transmitted from the consignor terminal apparatus and indicating a logical expression for selection of the image and/or the text to be inserted into the format of the advertising leaflet for the consignor.

9. The bundled advertising service providing system according to claim 8, wherein attribute information of a customer targeted for advertisement by the consignor and information indicating weighting given to the attribute information of the customer are associated with each other in the logical expression, and the logical expression is managed in association with information indicating an assignment position of the image and/or the text in the format of the advertising leaflet for the consignor.

10. The bundled advertising service providing system according to claim 9, wherein the hardware processor selects the image and/or the text using the logical expression based on the attribute information of the customer to whom the package scheduled to be sent is to be sent, and generates the advertising leaflet for the consignor by assigning the selected image and/or text to the format of the advertising leaflet for the consignor.

11. A method for providing a bundled advertising service by a bundled advertising service providing system including a platform providing apparatus that provides a consignor and an advertiser with a platform for the bundled advertising service for bundling an advertising leaflet in a package, the method comprising:
causing the platform providing apparatus to select, as an advertising leaflet to be bundled, an advertising leaflet with a high reward set for attribute information of a customer targeted by an advertiser that requests to bundle the advertising leaflet in the package, based on the attribute information of the customer to whom the package is to be sent; and
causing the platform providing apparatus to output, to a printing apparatus, an instruction to print document data of the selected advertising leaflet.

12. A non-transitory recording medium storing a computer-readable program for causing a computer to execute a method for providing a bundled advertising service by a bundled advertising service providing system including a platform providing apparatus that provides a consignor and an advertiser with a platform for the bundled advertising service for bundling an advertising leaflet in a package, the program causing the computer to:
cause the platform providing apparatus to select, as an advertising leaflet to be bundled, an advertising leaflet with a high reward set for attribute information of a customer targeted by an advertiser that requests to bundle the advertising leaflet in the package, based on the attribute information of the customer to whom the package is to be sent; and
cause the platform providing apparatus to output, to a printing apparatus, an instruction to print document data of the selected advertising leaflet.
